(19) United States
(12) Patent Application Publication
(10) Pub. No.: US 2014/0149184 A1
(43) Pub. Date: May 29, 2014

(54) SYSTEMS AND METHODS FOR SIMULATING A PRODUCT AT DIFFERENT ATTRIBUTES AND LEVELS

(71) Applicant: TATA CONSULTANCY SERVICES LIMITED, Mumbai (IN)

(72) Inventor: Soumen Ray, Bangalore (IN)

(73) Assignee: TATA CONSULTANCY SERVICES LIMITED, Mumbai (IN)

(21) Appl. No.: 14/091,184

(22) Filed: Nov. 26, 2013

(30) Foreign Application Priority Data
Nov. 27, 2012 (IN) 3373/MUM/2012

(51) Int. Cl. G06Q 30/02

(52) U.S. Cl. CPC G06Q 30/0206
USPC 705/7.35

(57) ABSTRACT

The present disclosure relates to conjoint analysis, and more particularly to systems and methods for simulating a new product at different price points and different attributes. In one embodiment, a method for simulating performance of a product is disclosed. The method comprises: providing a profile of the product and a corresponding choice card, wherein the choice card assists selecting of a sub-set of an updated first set of attributes and levels based on the profile; performing an analysis on the selected sub-set of the updated first set of attributes and levels; and simulating a plurality of scenarios to determine an optimum scenario depicting the performance of the product.

### PRIORITY CLAIM

This U.S. patent application claims priority under 35 U.S.C. §119 to: India Application No. 3373/MUM/2012, filed Nov. 27, 2012. The aforementioned application is incorporated herein by reference in its entirety.

### TECHNICAL FIELD

The present disclosure relates to conjoint analysis, and more particularly to systems and methods for simulating a new product at different price points and different attributes by analyzing the existing products in the market.

### BACKGROUND

With the development in the industrial sector, the frequency of new products introduction to the market has drastically increased. Corporates, in order to stay in competition, often need to analyze the market and make appropriate decisions before launching a new product and discontinuing the old products. It is difficult, however, for a brand manager to know the market share after introducing a product at a particular price point with particular attributes. Without knowing the performance of product to be launched in the future and the kind of response the product may achieve in the market, it is difficult to provide guidance to an assembly line for the manufacturing of the product. This can also affect the demand supply chain of a particular product and thus may lead to unnecessary investments.

While designing a new product, the brand manager often needs to have a complete overview of the current market. For example, the brand manager needs to create different market scenarios with change in price points of the company's own products or the competitor products, and acquire the knowledge of the share gain or loss of his new product. Moreover, before discontinuing a particular old product, the brand manager needs to understand the percentage of share the product contributes based on comparison among different brands.

The failure or success of a new product may largely depend on the precision of market analysis conducted before launching of the product. A detailed study may be required before finalizing the attributes and levels that may help in depicting the failure success ratio of the product to be launched. This type of market analysis is often referred to as conjoint analysis. In a conjoint analysis, the market share of existing products is analyzed and the different attributes and levels, such as packet size, shape, color, package, pricing and pack-sizes, are analyzed. In a conjoint analysis, a market survey can be conducted in order to analyze the existing products and derive attributes and levels for the new product to be launched.

But with the increase in the number of products, as well as the attributes and levels at which they are available, it becomes difficult to perform the conjoint analysis and derive the part-worth utility of each attribute at different price points. Current simulators are often not being built on the aggregated level models. These simulators do not have effective level-wise calibration of product attributes to simulate the performance of the product to be launched. Hence, these simulators do not have desired data to forecast future market share of the product that competes with similar products. Further, in the present scenario, the simulating tools available on the market also may not have capability of refining the product attributes and are limited to focus on the historical data obtained from market surveys. Moreover, the simulating tools often do not take account the instantaneous response from the users pertaining to attributes and the desired levels for determining future market share. This may result in forecasting incorrect or partially correct market share of the product to be launched. Additionally, the existing tools may lack prediction of future performance of the product by considering parameters such as elasticity and profitability of a new product at the time of designing or developing of a new product.

### SUMMARY

Before the present systems and methods, enablement are described, it is appreciated that this application is not limited to the particular systems, and methodologies described herein, as there can be multiple possible embodiments which are not expressly illustrated in the present disclosures. It is also appreciated that the terminology used in the description is for the purpose of describing the particular versions or embodiments only, and is not intended to limit the scope of the present application. This summary is provided to introduce aspects related to methods for simulating a new product at different price points and different attributes by analyzing the existing products in the market and the aspects are further described below in the detailed description. This summary is not intended to identify essential features of the claimed subject matter nor is it intended for use in determining or limiting the scope of the claimed subject matter.

In one embodiment, a method for simulating performance of a product is disclosed. The method comprises: providing a profile of the product and a corresponding choice card, wherein the choice card assists selecting of a sub-set of an updated first set of attributes and levels based on the profile; performing an analysis on the selected sub-set of the updated first set of attributes and levels to determine part-worth utilities of one or more attributes of the selected sub-set at different levels; and simulating, based on calibration of the selected sub-set of the updated first set of attributes at different selected levels and the part-worth utilities, a plurality of scenarios to determine an optimum scenario depicting the performance of the product.

In one embodiment, a system for simulating the performance of a product is disclosed. The system comprises a client machine; a central server coupled to a central repository; one or more processors in the central server; and a memory storing processor-executable instructions comprising instructions to: provide a profile of the product and a corresponding choice card, wherein the choice card assists selecting of a sub-set of an updated first set of attributes and levels based on the profile; perform an analysis on the selected sub-set of the updated first set of attributes and levels to determine part-worth utilities of one or more attributes of the selected sub-set at different levels; and simulate, based on calibration of the selected sub-set of the updated first set of attributes at different selected levels and the part-worth utilities, a plurality of scenarios to determine an optimum scenario depicting the performance of the product.

In one embodiment, a non-transitory computer program product having embodied thereon computer program instructions for simulating the performance of a product is disclosed. The instructions comprises instructions for: providing a profile of the product and a corresponding choice card, wherein the choice card assists selecting of a sub-set of an updated first set of attributes and levels based on the profile; performing an analysis on the selected sub-set of the updated first set of attributes and levels to determine part-worth utilities of one or more attributes of the selected sub-set at different levels; and simulating, based on calibration of the selected sub-set of the updated first set of attributes at different selected levels and the part-worth utilities, a plurality of scenarios to determine an optimum scenario depicting the performance of the product.

### BRIEF DESCRIPTION OF DRAWINGS

The accompanying drawings, which are incorporated in and constitute a part of this disclosure, illustrate exemplary embodiments and, together with the description, serve to explain the disclosed principles.

FIG. 1 is a block diagram illustrating an exemplary system for gathering historical data and analyzing for launching a new product, in accordance with an embodiment of the present subject matter.

FIG. 2 is a system architecture diagram illustrating an exemplary system comprising modules and hardware units for simulating market share of a new product, in accordance with an embodiment of the present subject matter.

FIG. 3 is a flow diagram illustrating an exemplary method for simulating a product at different attributes and levels, in accordance with an embodiment of the present subject matter.

### DETAILED DESCRIPTION

Exemplary embodiments are described with reference to the accompanying drawings. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

In some embodiments of the present disclosure, a system and method for simulating a new product at different attributes and levels is disclosed. The system can work on individual level modeling and generate market share within any market scenario by analyzing historical data associated with the existing products and extracting a historical set of attributes and levels. These historical set of attributes and levels may be updated with a new set of attributes and its associated levels obtained from a user in virtue of the future products. An updated set of attributes and levels can be generated. Further, the system may predict changes in variable entities, such as market share, elasticity, market revenue, and market volume. The simulator may take the part-worth utility of each of the updated attribute at different levels to derive the final market share of the new product. The simulator may also consider attributes such as distribution and availability of the goods for the prediction purpose. Thus, the user can have the flexibility to change both these attributes at the time of simulation.

In one embodiment, the simulator may predict the part-worth utilities of an updated set of attributes and levels by using hierarchical Bayesian technique. Further, the simulator may enable segment level market share generation for all products. A calibration factor may be used to match the survey based share with the current market share of the products. This calibration factor can be considered to adjust the sample mean and variance with population mean and variance in order to determine the distribution of that product. The distribution can be the percentage of market availability of a particular product corresponding to total market population. The simulator can have the flexibility to take care of private level total share at the time of projection of the final share.

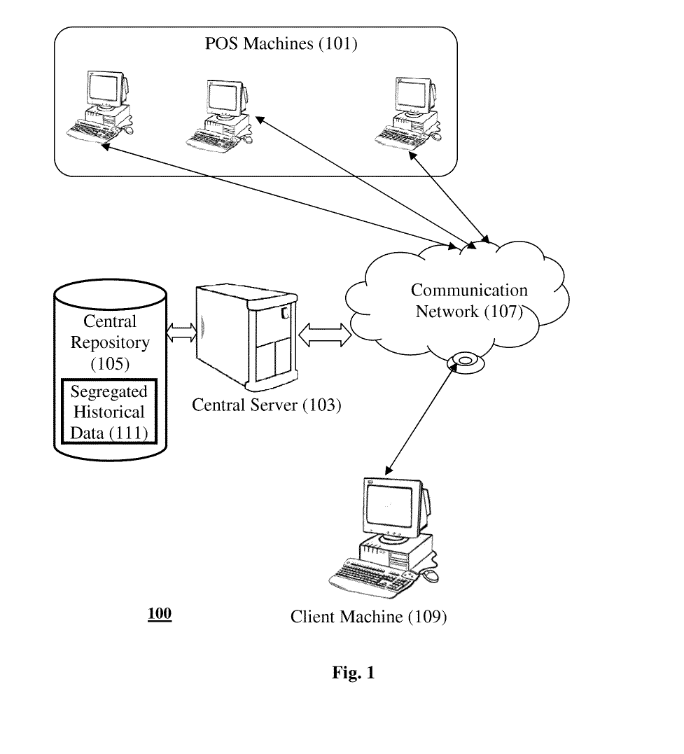

FIG. 1 is a block diagram illustrating an exemplary system 100 for gathering historical data and analyzing for launching a new product. The system 1100 comprises of a plurality of computing devices, such as POS (point of sale machines 101), a central server 103 coupled to a central repository 105 storing historic data 111, a client machine 109 with data transfer capabilities, and a communication network 107 enabling communication among the client machine 109, the central server 103 and the POS machines 101.

In some embodiments, the raw historical data from a plurality of POS machines 101 may be captured over a period of time and sent to the central server 103 via the communication network 107. The central server 103 may process the raw historical data from multiple sources and store it in the central repository 105 as segregated historical data 111. The processing of the raw historical data may take place at various stages in order to classify it into various historical attributes and levels associated with each product. The central server 103 may further analyze the segregated historical data 111 and generate a base-case scenario for new product simulation. One or more inputs are accepted from the client machine 109 regarding the introduction of new attributes and the variation in the level associated with the new product. These can be one or more sets of attributes for which there may not be historical data available in the central repository 105. Therefore, these attributes and levels may be instantaneously captured from the client machine 109. The attributes and levels may focus on future products similar to the product to be launched and their performance constraints. This information may be sent to the central server 103, which may combine the new attributes and the historical attributes to generate an update set of attributes and their associated levels. The new product may be modeled at various updated attributes and levels.

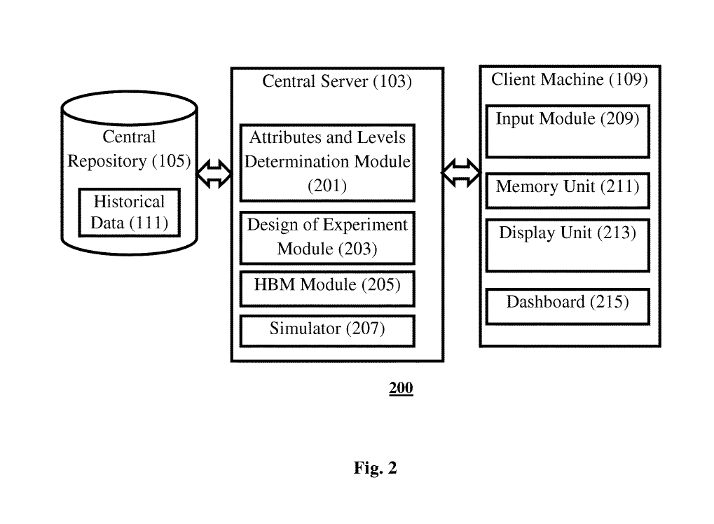

FIG. 2 is a system architecture diagram illustrating exemplary system 200 comprising modules and hardware units for simulating market share of a new product. The central server 103 may comprise an attributes and levels determination module 201, a design of experiments module 203), a choice module 205, and a simulator 207. The central server 103 can be coupled to a client machine 109 which may comprise an input module 209, a memory unit 211, a display unit 213, and a dashboard 215. The central repository 105 that stores the segregated historical data 111 may be coupled to the central server 103.

In some embodiments, the segregated historical data 111 stored in the central repository 105 may be analyzed by attributes and levels determination module 201 to extract the attributes such as the shape, color, and packaging of the product. Further, the attributes and levels determination module 201 may be configured to extract the different levels, such as price points, pack-sizes, etc., associated with the existing products in the market, on which the extracted attributes can be calibrated to generate plurality of scenarios. The attributes and levels determination module 201 may be initially configured to generate a base-case scenario. Based on the base-case scenario, the successive scenarios may be generated by using means of variance of different determined attributes on different levels, so as to derive a best-case scenario depicting the performance of the product that is to be launched.

In some embodiments, the attributes and levels determination module 201 may also enable considering of the new attributes and levels specified by a user related to products that are not available in the existing market. A need-state analysis may be performed in order to analyze probable attributes from the consumer. After the system identifies a need for additional attributes on the basis of the need-state analysis, these additional attributes can be included in the choice cards. In order to enable this, the input module 209 on the client machine 109 may be configured to accept the user input in the form of new attributes and levels. This input can be transmitted to the central server 103 via the communication network 107. In some embodiments, the design of experiment module 203 may enable the selection of a sub-set of attributes and levels to generate a design profile for the new product. The design of experiment module 203 may be configured to work on the principle of choice-based modeling, wherein a choice card can be made available for the user to select a sub-set of attributes and levels from the updated attributes and levels. The choice-based modeling may be performed to capture the interest of stakeholders that is correlated with the profile design of the new product.

In some embodiments, the output of the choice card may be accepted by a hierarchical Bayesian analysis module 205. The hierarchical Bayesian analysis module 205 may be configured to perform a hierarchical Bayesian model analysis on the selected sub-set of attributes and levels that result in determining of the part-worth utility for each of the selected sub-set of attribute at different levels. These part-worth utilities may be used as an input to the simulator 207. The simulator 207 may finalize the design and apply different statistical analysis techniques for predicting the future market share of the new product by considering the part-worth utilities and the availability of the product. For example, in some embodiments, the simulator 207 can intelligently enable calibration of product attributes at different levels to obtain a market share value at each level. A plurality of scenario analyses may be applied using multi-level product attributes to settle with an optimum combination of current market share, future market share, and the corresponding attribute to be adopted for the obtained desired share values. The dashboard 215 may be configured to generate various analytical information and statistical graphs that derive insights of the simulation analysis. Such interactive summary that is congruent with the variance of attributes corresponding to variance in levels may enable adjudging the best-case scenario that may result in positive impact for product marketing. The statistical graphs can be displayed on the display unit 109 of the client machine 213.

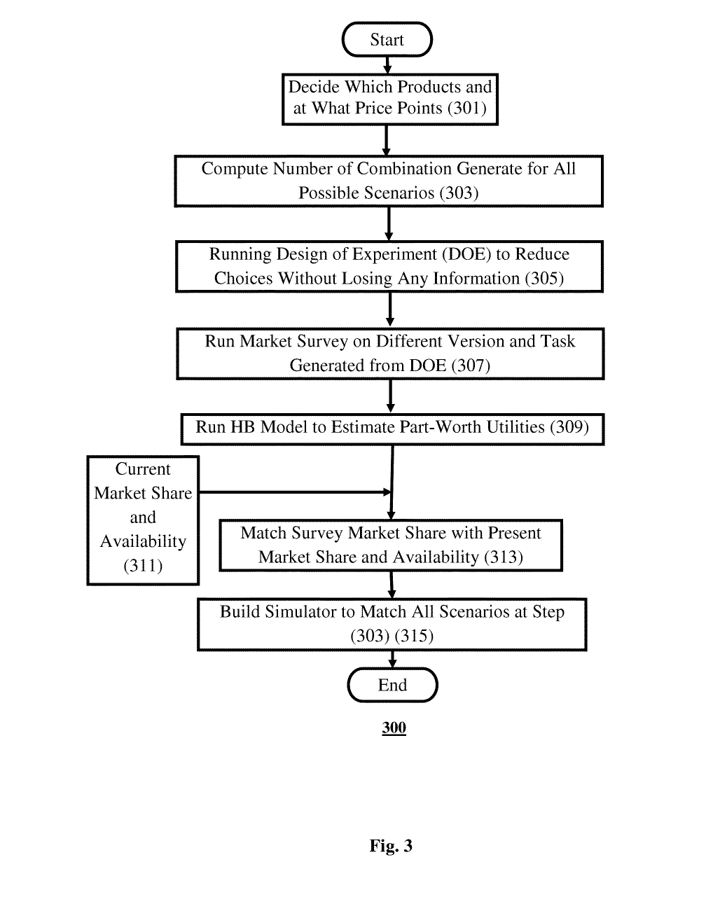

FIG. 3 is a flow diagram illustrating an exemplary method 300 for simulating a product at different attributes and levels. The method 300 may start at step 301, wherein the number of existing products to be analyzed is decided. The price points at which these products are to be analyzed may also be decided in this step. In some embodiments, one or more user inputs may be accepted provided by, for example, a client machine. The one or more user inputs may provide the number of products and their updated attributes and levels that are to be considered. At step 303 the number of combinations required to address a plurality of, or all, possible scenarios can be determined by the central server. At step 305 a design of experiment may be executed on the design profile to determine the minimum number of scenarios required to simulate the market share of the new product. This may be performed by applying a fractional factorial design technique to reduce the number of combinations without affecting the accuracy of the prediction.

At step 307, one or more market surveys may be conducted in order to obtain inputs from the user community regarding their preferences for a particular product with certain attributes at a particular price point. The inputs received from the one or more surveys can be analyzed using a hierarchical Bayesian technique to determine the part-worth utility of each attribute at the specified price point at step 309). At step 311, inputs, such as current market share of the products and the availability of the goods in the market, may be used by the simulator in order to predict the market share of the new product under simulation. At step 313, the survey-based share is compared with the present share of the product. The mean and standard deviation of the survey may be different from the mean and standard deviation of the population. The system can match sample mean and standard deviation from the DOE (design of experiment) output with the mean and standard deviation of the population. This test may represent the accuracy of the simulator in predicting the market share of the product. At step 315, one or more, or all, of the scenarios identified at step 303 may be simulated using the simulator.

In some embodiments, the method for simulating a new product may include defining one or more market scenarios; applying design of experiment to reduce the number of choices; performing market survey on the generated scenarios using choice cards; applying hierarchical Bayesian model to predict the part-worth utility; and using simulation technique to generate all scenarios. Analysis may be performed at each of these stages to determine the part-worth utility of each attribute.

In an exemplary embodiment, it may be desired to calculate a market share of a cosmetic product that is to be launched. The present disclosure can enable generation of a plurality of scenarios for determining the future market share. As an example, the simulation analysis may be conducted on eight similar cosmetic products having variable packet-size attribute including, for example, SKU1 350 mL, SKU2 473 mL, SKU3 500 mL, SKU4 591 mL, SKU5 750 mL, SKU6 473 mL, SKU7 475 mL, and SKU8 750 mL. The simulation process may be applied on these cosmetic products in different stages to obtain the market share of the new cosmetic product to be launched. The simulation process is explained in detail below.

For illustrating the simulation process, one scenario is considered wherein only price is varied with respect to the packet-size attribute. It is appreciated that a simulation process can be applied to any number of scenarios and any number of attributes at any number of levels. For this scenario, Table I below illustrates the possible combinations of prices that may be associated with various packet-size attributes for five different price levels.

TABLE I

| SKU | Packet | | | | | |
|---|---|---|---|---|---|---|
| Name | Size | Price 1 | Price 2 | Price 3 | Price 4 | Price 5 |
| SKU1 | 350 | 1.50 | 1.60 | 1.70 | 1.80 | 2.00 |
| 350 mL | | | | | | |
| SKU2 | 473 | 2.00 | 2.10 | 2.20 | 2.30 | 2.50 |
| 473 mL | | | | | | |
| SKU3 | 500 | 2.00 | 2.10 | 2.30 | 2.50 | 2.70 |
| 500 mL | | | | | | |
| SKU4 | 591 | 3.00 | 3.10 | 3.20 | 3.30 | 3.50 |
| 591 mL | | | | | | |
| SKU5 | 750 | 3.00 | 3.10 | 3.30 | 3.50 | 4.00 |
| 750 mL | | | | | | |
| SKU6 | 473 | 1.50 | 1.60 | 1.70 | 1.80 | 2.00 |
| 473 mL | | | | | | |
| SKU7 | 475 | 1.50 | 1.60 | 1.70 | 1.80 | 2.00 |
| 475 mL | | | | | | |
| SKU8 | 750 | 2.50 | 2.60 | 2.70 | 2.80 | 3.00 |
| 750 mL | | | | | | |
| All | 475 | | | | | |
| Other | | | | | | |

In this exemplary embodiment, after the definition of pricing scenarios, the next step may be to accept the user preferences for possible combinations. The number of combinations may be determined by means of full factorial consideration principle for the defined scenarios. For example, in the above example, eight products and five different price levels would generate 5⁸=390,625 different combinations. However, in accordance with the present disclosure, this number of combinations may be reduced to 180 by applying fractional factorial technique using an orthogonal array concept.

In some embodiments, the fractional factorial technique may preserve only those entries that can create an impact over the prediction of part-worth of each attribute while eliminating the other redundant entries. This may result in generation of the choice card, which is illustrated in the table-II:

TABLE II

| | | Price | Price | Price | Price | Price | Price | Price | Price |
|---|---|---|---|---|---|---|---|---|---|
| | Product | sku1 | sku2 | sku3 | sku4 | sku5 | sku6 | sku7 | sku8 |
| Choice | SKU1 | 1 | 0 | 0 | 0 | 0 | 0 | 0 | 0 |
| Card 1 | SKU3 | 0 | 0 | 5 | 0 | 0 | 0 | 0 | 0 |
| | SKU5 | 0 | 0 | 0 | 0 | 4 | 0 | 0 | 0 |
| | SKU6 | 0 | 0 | 0 | 0 | 0 | 3 | 0 | 0 |
| | SKU7 | 0 | 0 | 0 | 0 | 0 | 0 | 1 | 0 |
| | SKU8 | 0 | 0 | 0 | 0 | 0 | 0 | 0 | 4 |
| . . . | | | | | | | | | |
| . . . | | | | | | | | | |
| Choice | SKU1 | 3 | 0 | 0 | 0 | 0 | 0 | 0 | 0 |
| Card | SKU2 | 0 | 2 | 0 | 0 | 0 | 0 | 0 | 0 |
| 180 | SKU5 | 0 | 0 | 0 | 0 | 4 | 0 | 0 | 0 |
| | SKU6 | 0 | 0 | 0 | 0 | 0 | 1 | 0 | 0 |
| | SKU7 | 0 | 0 | 0 | 0 | 0 | 0 | 5 | 0 |
| | SKU8 | 0 | 0 | 0 | 0 | 0 | 0 | 0 | 5 |

In some embodiments, the scenarios depicted in the choice card may be displayed to respondents one at a time. The choice card may be used to capture inputs from the respondents in the form of “+1” and “−1,” respectively, as per their choice. In a similar manner, multiple scenarios can be generated for different attributes and inputs from respondents for the multiple scenarios that are captured. New probable attributes, such as package size, may also be identified in this step by performing a need-state analysis, which may be optional and may depend on the user preference as per the new product requirements. In some embodiments, all the choice cards may be provided for conducting a hierarchical Bayesian model analysis.

In some embodiments, the choice cards may be provided into the system and a hierarchical Bayesian analysis can be performed on each of the attributes. The output of the hierarchical Bayesian analysis is the part-worth utility determined of each attributes that are extracted from the choice card. In the above example of the cosmetic products, the part-worth utilities generated by the hierarchical Bayesian analysis may be illustrated in Table-III below:

TABLE III

| | Initial Pred. | Adjustment | |
|---|---|---|---|
| SKU Name | Share | Factor | Pred. Share |
| SKU1 350 mL | | 0 | |
| SKU2 473 mL | 25.1567 | 1.1057342 | 29.7726 |
| SKU3 500 mL | | 0 | |
| SKU4 591 mL | 16.1553 | 0.2873795 | 6.9741 |
| SKU5 750 mL | | 0 | |
| SKU6 473 mL | 14.6871 | 0.9541241 | 17.7362 |
| SKU7 475 mL | 39.7896 | 1.0032643 | 40.6419 |
| SKU8 750 mL | | 0 | |
| All Other | 4.2113 | 3.5213743 | 4.8752 |

In some embodiments, the “adjustment factor” may be utilized to perform further study on each sample. Under some circumstances, the results from the study may not match with the population and industry level results. And the adjustment factor may help to match sample results with population results. This is a calibration factor that is calculated from samples, industry and population. This factor may be the same for a particular study but may be varied across different studies.

In some embodiments, one or more, or all, of the part-worth utilities associated with the attributes are provided to the simulator. The simulator may be adapted to determine the impact of each part-worth utility and accordingly simulate the market share for the new product to be launched. The output of the simulator can be one or more analytical graphs depicting the future market share of the new product, the change in market share based upon the variations introduced by the user with respect to each attribute and combinations thereof.

In some embodiments, the present subject matter may enable prediction of market share of a new product to be launched by analyzing the existing products at different attributes and levels. The present subject matter may also provide a simulator, which can accurately predict the part-worth utility of an attribute based upon the limited historical data. The present subject matter may further enable introducing of new attributes and levels associated with the new product and performing analysis to determine part-worth utilities of each new attribute at different levels. The present subject matter may further enable using hierarchical Bayesian model in combination with fractional factorial design to correctly identify the part-worth utility of a product using a limited number of combinations of levels and attributes.

In some embodiments, the present subject matter may provide a system and method to enable simulator tools that are capable of simulating different market scenarios for predicting the market share of a new product to be launched. The present subject matter may also provide a system and method that can enable efficient prediction of market share of a particular product using a limited set of historical data. The present subject matter may further provide a system and method that provides an interactive dashboard displaying the results of calibration oriented scenario analysis to arrive at a conclusion with an optimum combination and scenario. The present subject matter may also provide a system and method that enables multi-level attribute-based scenario analysis by referring a plurality of libraries that store historical information and thereby facilitating data reusability. The present disclosure may further provide a system and method that enables instantaneous capturing of new set of attributes and levels unavailable through historical data from the consumers on future product portfolios. The present disclosure may further predict the part-worth utilities for the attributes and levels obtained from both historical data and those captured from the users. The present disclosure may further enable a system and method which is built on the hierarchical model output where user has flexibility to generate different market scenarios and visualize the results to determine the best possible scenario.

The methodology and techniques described with respect to the exemplary embodiments can be performed using a computer-implemented system or other computing device within which a set of instructions, when executed, may cause the said computer-implemented system to perform any one or more of the methodologies discussed above. The said computer-implemented system may include a processor included within the said computer-implemented system, which can be configured to execute the said programmed instructions or the said set of instructions. The said computer-implemented system can be configured from different modules. Each module can be configured for executing programmed instructions or set of instruction to perform a particular task. According to the embodiments of the present subject matter, the computer-implemented system may also operate as a standalone device.

Although implementations for methods and systems for simulating performance of a product have been described in language specific to structural features and/or methods, it is to be understood that the appended claims are not necessarily limited to the specific features or methods described. Rather, the specific features and methods are disclosed as examples of implementations for simulating performance of a product.

What is claimed is:

1. A method for simulating performance of a product, the method being performed by a processor using programmed instructions stored in a memory, the method comprising:
providing a profile of the product and a corresponding choice card, wherein the choice card assists selecting of a sub-set of an updated first set of attributes and levels based on the profile;
performing an analysis on the selected sub-set of the updated first set of attributes and levels to determine part-worth utilities of one or more attributes of the selected sub-set at different levels; and
simulating, based on calibration of the selected sub-set of the updated first set of attributes at different selected levels and the part-worth utilities, a plurality of scenarios to determine an optimum scenario depicting the performance of the product.

2. The method of claim 1, further comprising, prior to providing the profile of the product and the corresponding choice card:
retrieving historical data associated with one or more existing products to determine a first set of attributes and levels associated with the first set of attributes; and
updating the first set of attributes and levels based on a second set of attributes and levels associated with the second set of attributes, the second set of attributes and levels being obtained corresponding to the product.

3. The method of claim 1, wherein the first set of attributes comprises one or more of shape of the product, color of a packet, and type of packaging.

4. The method of claim 1, wherein the levels associated with the first set of attributes comprises one or more of different price points and pack-sizes.

5. The method of claim 1, wherein providing the profile of the product and the corresponding choice card comprises designing the choice card to determine the preferences of a plurality of users, the preferences being related to the one or more existing products at the updated first set of attributes and levels.

6. The method of claim 1, wherein providing the profile of the product and the corresponding choice card comprises is based on fractional factorial design that enables reducing a number of the scenarios and estimating the part-worth utilities of the product.

7. The method of claim 1, wherein the analysis is a hierarchical Bayesian model analysis.

8. A system for simulating the performance of a product, the system comprising:
one or more processors; and
a memory storing processor-executable instructions comprising instructions to:
provide a profile of the product and a corresponding choice card, wherein the choice card assists selecting of a sub-set of an updated first set of attributes and levels based on the profile;
perform an analysis on the selected sub-set of the updated first set of attributes and levels to determine part-worth utilities of one or more attributes of the selected sub-set at different levels; and
simulate, based on calibration of the selected sub-set of the updated first set of attributes at different selected levels and the part-worth utilities, a plurality of scenarios to determine an optimum scenario depicting the performance of the product.

9. The system of claim 8, wherein the instructions further comprising, prior to the instructions to provide the profile of the product and the corresponding choice card, instructions to:
retrieve historical data associated with one or more existing products to determine a first set of attributes and levels associated with the first set of attributes; and
update the first set of attributes and levels based on a second set of attributes and levels associated with the second set of attributes, the second set of attributes and levels being obtained corresponding to the product.

10. The system of claim 8, wherein the first set of attributes comprises one or more of shape of the product, color of a packet, and type of packaging.

11. The system of claim 8, wherein the levels associated with the first set of attributes comprises one or more of different price points and pack-sizes.

12. The system of claim 8, wherein the instructions further comprising instructions to comprises designing the choice card to determine the preferences of a plurality of users, the preferences being related to the one or more existing products at the updated first set of attributes and levels.

13. The system of claim 8, wherein the instructions further comprising instructions to provide a profile of the product and a corresponding choice card based on fractional factorial design that enables reducing a number of the scenarios and estimating the part-worth utilities of the product.

14. The system of claim 8, wherein the second set of attributes and levels are provided by a user.

15. The system of claim 8, wherein the analysis is a hierarchical Bayesian model analysis.

16. A non-transitory computer program product having embodied thereon computer program instructions for simulating performance of a product, the instructions comprising instructions for:
providing a profile of the product and a corresponding choice card, wherein the choice card assists selecting of a sub-set of an updated first set of attributes and levels based on the profile;
performing an analysis on the selected sub-set of the updated first set of attributes and levels to determine part-worth utilities of one or more attributes of the selected sub-set at different levels; and
simulating, based on calibration of the selected sub-set of the updated first set of attributes at different selected levels and the part-worth utilities, a plurality of scenarios to determine an optimum scenario depicting the performance of the product.

17. The computer program product of claim 16, wherein the instructions further comprising, prior to the instructions to provide the profile of the product and the corresponding choice card, instructions for:
retrieving historical data associated with one or more existing products to determine a first set of attributes and levels associated with the first set of attributes;
updating the first set of attributes and levels based on a second set of attributes and levels associated with the second set of attributes, the second set of attributes and levels being obtained corresponding to the product.

18. The computer program product of claim 16, wherein the first set of attributes comprises one or more of shape of the product, color of a packet, and type of packaging.

19. The computer program product of claim 16, wherein the levels associated with the first set of attributes comprises one or more of different price points and pack-sizes.

20. The computer program product of claim 16, wherein providing the profile of the product and the corresponding choice card comprises designing the choice card to determine the preferences of a plurality of users, the preferences being related to the one or more existing products at the updated first set of attributes and levels.

21. The computer program product of claim 16, wherein providing the profile of the product and the corresponding choice card comprises is based on fractional factorial design that enables reducing a number of the scenarios and estimating the part-worth utilities of the product.

22. The computer program product of claim 16, wherein the analysis is a hierarchical Bayesian model analysis.
